(19) United States
(12) Patent Application Publication
(10) Pub. No.: US 2006/0012701 A1
(43) Pub. Date: Jan. 19, 2006

(54) Auto-stabilization method in control of driving image pickup device and reading memory and photographing apparatus having the same

(75) Inventor: Sung-bin Hong, Yongin-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/143,611

(22) Filed: Jun. 3, 2005

(30) Foreign Application Priority Data
Jul. 19, 2004 (KR) 2004-56001

(51) Int. Cl. H04N 5/232

(52) U.S. Cl. 348/345

(57) ABSTRACT

Provided are an auto-stabilization method of controlling driving an image pickup device and reading a memory, and a photographing apparatus having the auto-stabilization method. The photographing apparatus includes an image pickup device photographing an optical image of an object focused on an optical surface including an effective pixel area and a reserved pixel area of predetermined size prepared outside the effective pixel area to generate an image signal. An image pickup device driver drives the image pickup device to output an image signal generated in a pixel area greater than the effective pixel area. A signal processor performs predetermined signal processing on the image signal output from the image pickup device. A memory stores the image signal that has undergone the predetermined signal processing in the unit of field. An auto-stabilizer produces an auto-stabilized area using the image signal stored in the memory.

### CROSS-REFERENCE TO RELATED APPLICATIONS

This application claims the benefit under 35 U.S.C. § 119(a) of Korean Patent Application No. 2004-56001, filed on Jul. 19, 2004, in the Korean Intellectual Property Office, the entire disclosure of which is hereby incorporated by reference.

### BACKGROUND OF THE INVENTION

1. Field of the Invention

The present invention relates to an auto-stabilization method and a photographing apparatus adopting the same. More particularly, the present invention relates to an auto-stabilization method of detecting and stabilizing hand shaking of a photographer to prevent the deterioration of image quality caused by the hand shaking and a photographing apparatus having the same.

2. Description of the Related Art

When a photographer photographs with a photographing apparatus, the photographing apparatus shakes due to shaking of the photographer's hand. This results in shaking of an image photographed by the photographing apparatus.

Accordingly, the photographing apparatus has a function of automatically detecting and stabilizing hand shaking to photograph a clear image without being shaken. This function is called auto-stabilization (AS). The AS function includes processes of detecting and stabilizing hand shaking.

A currently used AS method may be roughly classified into digital image stabilization (DIS), electrical image stabilization (EIS), and optical image stabilization (OIS) methods.

In the DIS method, hand shaking is detected and stabilized using an image signal stored in a memory. To stabilize hand shaking, a motion vector is detected using an image signal generated by an image pickup device and stored in a memory, and then a reading timing of the memory is changed using the detected motion vector.

According to the DIS method, an AS function may be simply embodied. However, a size of an image that can be read from the memory by the changed reading timing is equal to a size of an effective pixel area. Thus, the read image must be magnified through digital zoom and then reproduced and/or recorded. As a result of the digital zoom, the quality of the reproduced and/or recorded image may be deteriorated.

In the EIS method, hand shaking is detected and stabilized using an angular velocity sensor and a high pixel image pickup device. Specifically, an amount and direction of hand shaking are detected using a horizontal and vertical angular velocity sensor. Next, hand shaking is stabilized by changing an output timing of the high pixel image pickup device using the detected amount and direction of hand shaking.

In the case of the EIS method, a size of an image constituted by an image signal output from the high pixel image pickup device by the changed output timing is equal to a size of an original image. This is because a total number of pixels is much larger than a number of effective pixels in the high pixel image pickup device used in the EIS method. Thus, according to the EIS method, the quality of a reproduced and/or recorded image is not deteriorated. However, the angular velocity sensor and the high pixel image pickup device are required to perform the EIS method. This causes manufacturing unit costs to be increased.

The OIS method detects and stabilizes hand shaking using an angular velocity sensor and a prism. The OIS method is the same as the EIS method in that an amount and direction of hand shaking are detected using a horizontal and vertical angular velocity sensor. However, the OIS method is different from the EIS method in that the prism is used to change a path of light incident on an image pickup device when stabilizing hand shaking.

In the OIS method, the quality of a reproduced and/or recorded image is not deteriorated, and a high pixel image pickup device is not required. However, since the angular velocity sensor and the prism are required to perform the OIS method, the bulk and manufacturing unit costs of a photographing apparatus increase. In addition, it is difficult to control the prism.

Accordingly, a need exists for an improved auto-stabilization method for photographing apparatus that substantially eliminates deteriorated pictures due to shaking of the photographing apparatus.

### SUMMARY OF THE INVENTION

Accordingly, an aspect of the present general inventive concept is to provide an AS method of minimizing a deterioration of the quality of a photographed image without using an angular velocity sensor, a prism, and a high pixel image pickup device that causes manufacturing unit costs of a photographing apparatus to increase and the photographing apparatus having the same.

According to an aspect of the present invention, a photographing apparatus includes an image pickup device for photographing an optical image of an object focused on an optical surface including an effective pixel area and a reserved pixel area of predetermined size prepared outside the effective pixel area to generate an image signal. An image pickup device driver drives the image pickup device to output an image signal generated in a pixel area greater than the effective pixel area. A signal processor performs predetermined signal processing on the image signal output from the image pickup device. A memory stores the image signal that has undergone the predetermined signal processing in the unit of field. An auto-stabilizer produces an auto-stabilized area using the image signal stored in the memory.

The photographing apparatus may further include a memory controller reading an image signal corresponding to the auto-stabilized area from the memory, and a display unit reproducing the image signal read by the memory controller.

The image pickup device may drive the image pickup device to output image signals generated in the effective and reserved pixel areas.

The image pickup device may be one of a charge coupled device and a metal oxide semiconductor type image pickup device. The image pickup device may be used in one of a digital camera, a digital camcorder, a monitoring camera, and a camera built in a mobile phone.

According to another aspect of the present invention, an auto-stabilization method for a photographing apparatus includes an image pickup device for photographing an optical image of an object focused on an optical surface including an effective pixel area and a reserved pixel area of predetermined size prepared outside the effective pixel area to generate an image signal. The auto-stabilization method includes driving the image pickup device to output an image signal generated in a pixel area greater than the effective pixel area; performing predetermined signal processing on the image signal output from the image pickup device. The image signal that has undergone the predetermined signal processing is stored in the unit of field. An auto-stabilized area is produced using the stored image signal.

The auto-stabilization method may further include reading an image signal corresponding to the auto-stabilized area, and reproducing the read image signal.

The image pickup device may be driven to output image signals generated in the effective and reserved pixel areas.

The image pickup device may be one of a charge coupled device and a metal oxide semiconductor type image pickup device.

The photographing apparatus may be one of a digital camera, a digital camcorder, a monitoring camera, and a camera built in a mobile phone.

Other objects, advantages and salient features of the invention will become apparent from the following detailed description, which, taken in conjunction with the annexed drawings, discloses preferred embodiments of the invention.

### BRIEF DESCRIPTION OF THE DRAWINGS

The above aspects and features of the present invention will be more apparent by describing certain embodiments of the present invention with reference to the accompanying drawings, in which:

FIG. 1 is a block diagram of a photographing apparatus for stabilizing hand shaking in control of driving an image pickup device and reading a memory according to an embodiment of the present invention;

FIG. 2A illustrates an optical surface of a Charge Coupled Device (CCD);

FIG. 2B is a timing diagram of a CCD drive pulse for outputting an image signal generated in an effective pixel area of the CCD;

FIG. 2C is a timing diagram of a CCD drive pulse for outputting an image signal generated in a whole pixel area (including the effective pixel area and a reserved pixel area) of the CCD;

FIG. 3A illustrates a memory storing the image signal generated in the whole pixel area of the CCD;

FIG. 3B illustrates an auto-stabilized area to be read from the memory; and

FIG. 4 is a flowchart of an AS method by controlling driving an image pickup device and reading a memory according to an embodiment of the present invention.

Throughout the drawings, like reference numerals will be understood to refer to like parts, components and structures.

### DETAILED DESCRIPTION OF EXEMPLARY EMBODIMENTS

Certain exemplary embodiments of the present invention will be described in greater detail with reference to the accompanying drawings.

The matters defined in the description, such as a detailed construction and elements thereof, are provided to assist in a comprehensive understanding of the invention. Thus, it is apparent that the present invention may be carried out without those defined matters. Also, well-known functions or constructions are omitted in detail to provide a clear and concise description of the exemplary embodiments of the present invention.

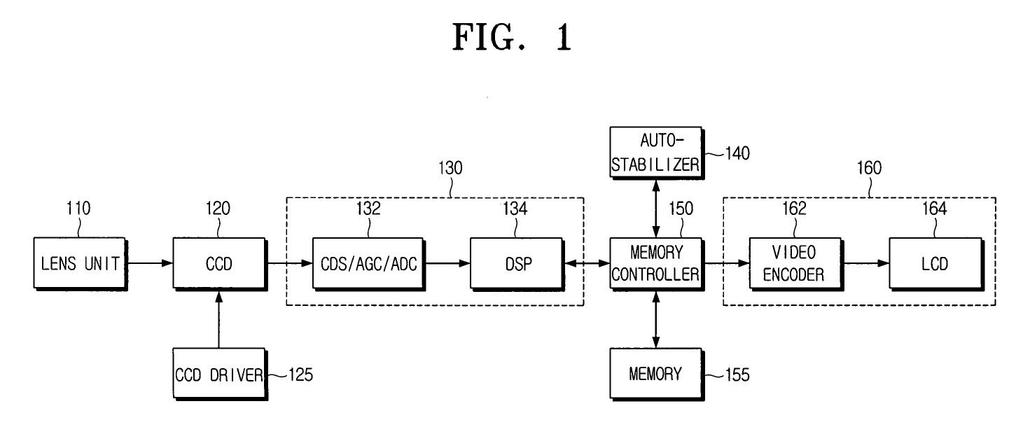

FIG. 1 is a block diagram of a photographing apparatus for stabilizing hand shaking by controlling driving an image pickup device and reading a memory according to an exemplary embodiment of the present invention. Referring to FIG. 1, the photographing apparatus includes a lens unit 110, a CCD 120, a CCD driver 125, a signal processor 130, an auto-stabilizer 140, a memory controller 150, a memory 155, and a display unit 160.

The lens unit 110 focuses an optical image of an object on an optical surface of the CCD 120.

The CCD 120 is an image pickup device that photographs the optical image of the object focused on the optical surface to generate an image signal corresponding to the optical image. The photographing apparatus of an exemplary embodiment of the present invention may be embodied using a Metal Oxide Semiconductor (MOS) type image pickup device in lieu of the CCD 120.

The CCD driver 125 drives the CCD 120 to output the image signal generated by the CCD 120 to the signal processor 130. The CCD driver 125 applies a CCD drive clock to the CCD 120 so that the CCD 120 outputs the image signal. A pixel area on the optical surface of the CCD 120 outputting the image signal and a size of the pixel area are determined depending on the CCD drive clock.

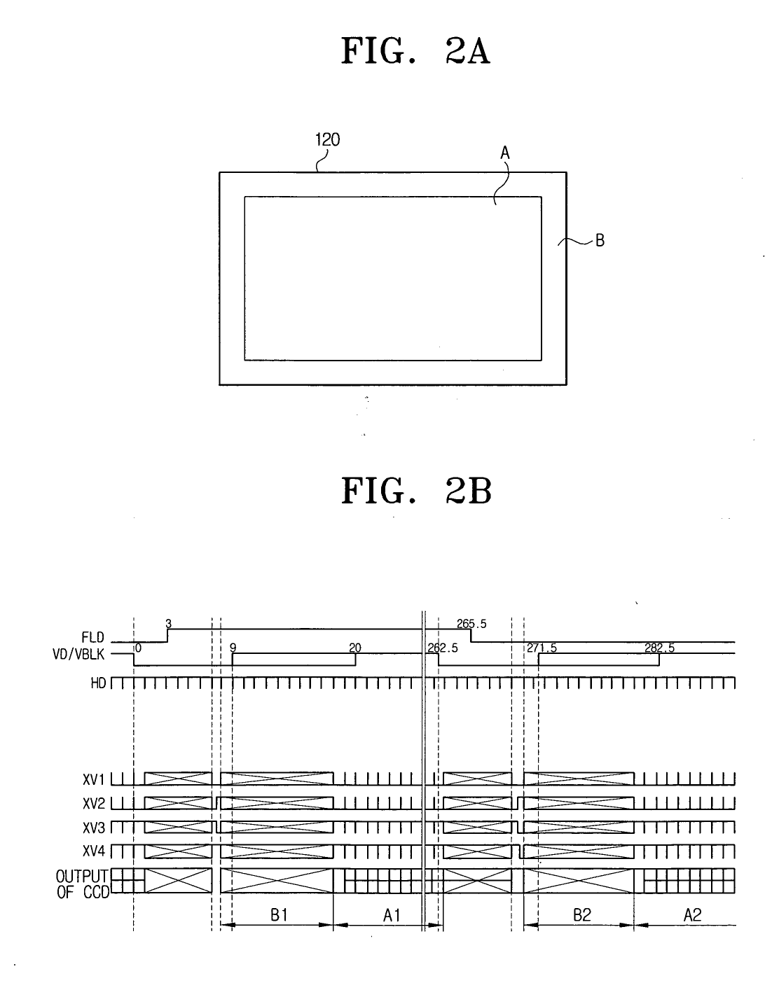

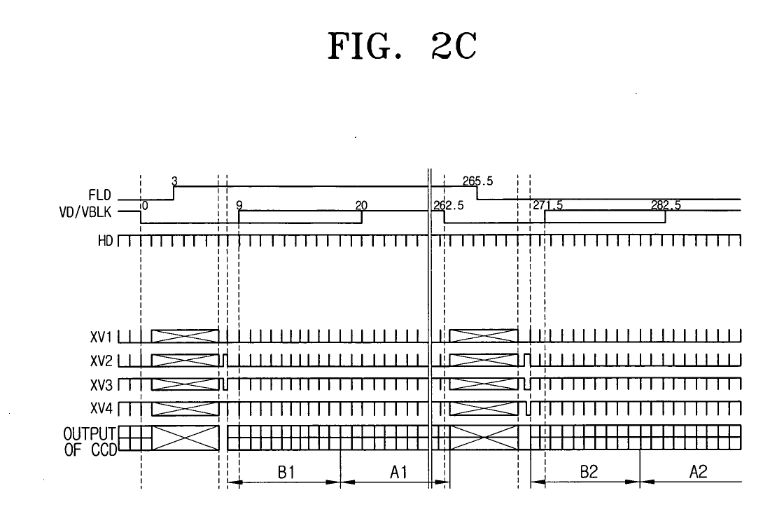

Control of driving the CCD 120 will now be described in detail with reference to FIGS. 2A through 2C. FIG. 2A illustrates the optical surface of the CCD 120. Referring to FIG. 2A, the optical surface of the CCD 120 includes an effective pixel area A and a reserved pixel area B of predetermined size prepared outside the effective pixel area A.

Conventionally, the CCD driver 125 drives the CCD 120 to output only an image signal generated in the effective pixel area A. FIG. 2B is a timing diagram of the CCD drive clock the CCD driver 125 applies to the CCD 120. Timings of a field clock FLD, a vertical synchronizing/vertical blacking clock VD/VBLK, a horizontal synchronizing clock HD, and vertical transmission clocks XVI through XV4 as the CCD drive clock the CCD driver 125 applies to the CCD 120 are shown in FIG. 2B. A timing of an output of the CCD 120 is also shown at the lowermost part of the timing diagram shown in FIG. 2B.

As shown in FIG. 2B, since the CCD driver 125 does not apply the vertical transmission clocks XVI through XV4 to the CCD 120 in sections B1 and B2, there is no output of the CCD 120 in the sections B1 and B2. The CCD 120 does not output the image signal in the sections B1 and B2 but outputs the image signal only in sections A1 and A2. Thus, only the image signal generated in the effective pixel area A of the CCD 120 is output to the signal processor 130, and the image signal generated in the reserved pixel area B of the CCD 120 is not output to the signal processor 130. Conventionally, the image signal generated in the reserved pixel area B of the CCD 120 is not used.

However, in the present invention, the CCD driver 125 may drive the CCD 120 to output the image signal generated in the reserved pixel area B as well as the image signal generated in the effective pixel area A. FIG. 2C is a timing diagram of the CCD drive clock the CCD driver 125 applies to the CCD 120.

As shown in FIG. 2C, since the CCD driver 125 applies the vertical transmission clocks XVI through XV4 to the CCD 120 in the sections B1 and B2 as well as in the sections A1 and A2, the CCD 120 outputs the image signal even in the sections B1 and B2. Thus, the image signals generated in the effective and reserved pixel areas A and B of the CCD 120 are output to the signal processor 130. As a result, the image signal generated in the reserved pixel area B of the CCD 120 may also be used. The image signal generated in the reserved pixel area B of the CCD 120 is used for AS. This will be described in more detail below.

Referring to FIG. 1 again, the signal processor 130 performs predetermined signal processing on the image signal output from the CCD 120. The signal processor 130 includes a correlated double sampling circuit (CDS)/auto gain controlling circuit (AGC)/analog-to-digital converter (ADC) 132 and the DSP 134.

The CDS/AGC/ADC 132 removes noise from the image signal output from the CCD 120 using a CDS, adjusts a gain using an AGC to uniformly maintain the level of the image signal, and converts the image signal into a digital image signal using an ADC. The DSP 134 performs signal processing, such as auto white balance (AWB) on the digital image signal output from the CDS/AGC/ADC 132.

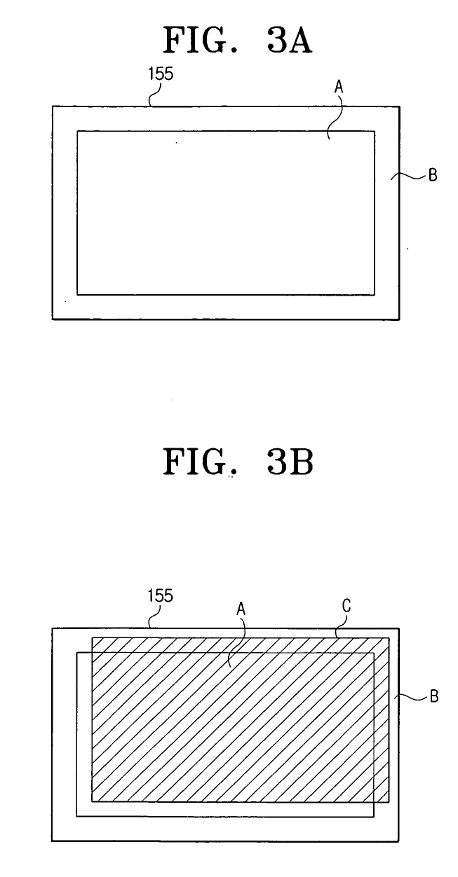

The memory controller 150 stores the image signal output from the DSP 134 in the memory 155 in the unit of field. Since the image signal output from the CCD 120 is the image signals generated in the effective and reserved pixel areas A and B, an image stored in the memory 155 is an image photographed in the whole pixel area (including the effective and reserved pixel areas A and B) as shown in FIG. 3A. FIG. 3A illustrates the memory 155 storing the image signal generated in the whole pixel area of the CCD 120.

Thereafter, the memory controller 150 reads the image signal from the memory 155 in the unit of field and applies the image signal to the auto-stabilizer 140.

The auto-stabilizer 140 detects hand shaking using the image signal applied from the memory controller 150. The auto-stabilizer 140 compares fields of the applied image signal to detect an amount and direction of hand shaking. The auto-stabilizer 140 also produces an auto-stabilized area based on the detected amount and direction of hand shaking. A size of the auto-stabilized area is substantially equal to a size of the effective pixel area A. FIG. 3B illustrates an example of the auto-stabilized area (marked with slanted lines), which is denoted by reference character C.

The auto-stabilizer 140 applies information as to the auto-stabilized area to the memory controller 150.

The memory controller 150 reads an image signal corresponding to the auto-stabilized area from the memory 155 using the information as to the auto-stabilized area and applies the read image signal to the display unit 160.

The memory controller 150 reads an image signal corresponding to the auto-stabilized area C of areas shown in FIG. 3B from the memory 155 and applies the read image signal to the display unit 160. Since a size of the auto-stabilized area C is substantially equal to the size of the effective pixel area A, a size of the image signal read by the memory controller 150 is also substantially equal to the size of the effective pixel area A.

The display unit 160 reproduces the image signal read by the memory controller 150. The display unit 160 includes a video encoder 162 and a liquid crystal display (LCD) 164.

The video encoder 162 converts the image signal output from the memory controller 150 into an image signal that may be reproduced by the LCD 164. The LCD 164 is a display device that displays the image signal converted by the video encoder 162.

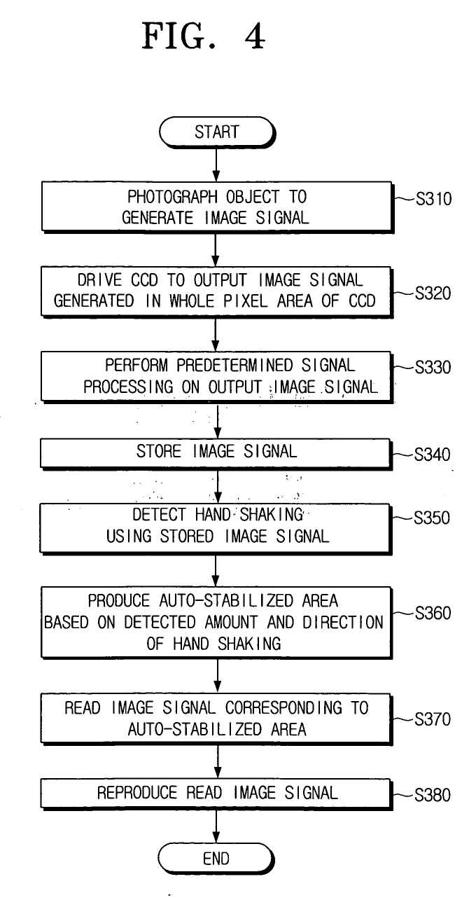

An AS method of controlling driving the CCD 120 and reading the memory 155 in the photographing apparatus shown in FIG. 1 will now be described in detail with reference to FIG. 4. FIG. 4 is a flowchart of an AS method including controlling driving an image pickup device and reading a memory, according to an exemplary embodiment of the present invention. Referring to FIG. 4, in step S310, the CCD 120 photographs the optical image of the object focused on the optical surface to produce the image signal corresponding to the optical image.

In step S320, the CCD driver 125 drives the CCD 120 to output the image signal generated in the whole pixel area of the CCD 120 to the signal processor 130. The CCD driver 125 applies the CCD drive clock as shown in FIG. 2C to the CCD 120 so that the CCD 120 outputs the image signals generated in the effective and reserved pixel areas A and B.

In step S330, the signal processor 130 performs the predetermined signal processing on the image signal output from the CCD 120.

In step S340, the memory controller 150 stores the image signal output from the signal processor 130 in the memory 155 in the unit of field. Since the image signal output from the CCD 120 is the image signal generated in the whole pixel area (including the effective and reserved pixel areas A and B), the image stored in the memory 155 is also the image photographed in the whole pixel area of the CCD 120. Storing the image photographed in the whole pixel area of the CCD 120 in the memory 155 is as shown in FIG. 3A.

In step S350, the auto-stabilizer 140 detects hand shaking using the image signal stored in the memory 155. The auto-stabilizer 140 receives the image signal stored in the memory 155 in the unit of field from the memory controller 150 and compares the fields of the received image signal to detect the amount and direction of hand shaking.

In step S360, the auto-stabilizer 140 produces the auto-stabilized area based on the amount and direction of hand shaking. The auto-stabilizer 140 also applies the information as to the auto-stabilized area to the memory controller 150.

In step S370, the memory controller 150 reads the image signal corresponding to the auto-stabilized area from the memory 155 using the information as to the auto-stabilized area and applies the read image signal to the display unit 160. The memory controller 150 reads the image signal corresponding to the auto-stabilized area C of the areas shown in FIG. 3B from the memory 155 and applies the read image signal to the display unit 160.

In step S380, the display unit 160 reproduces the image signal read by the memory controller 150. In addition, the image signal read by the memory controller 150 may be compressed in a predetermined format and then recorded in a recording medium (not shown).

The AS method of controlling driving the CCD 120 and reading the memory 155 has been described. It has been described in an exemplary embodiment that the CCD driver 125 drives the CCD 120 to output the image signal generated in the whole pixel area of the CCD 120. However, the present invention is not necessarily limited to this. The CCD drivers 125 drive the CCD 120 to output only an image signal generated in a pixel area (a portion of the effective and reserved pixel areas A and B) greater than the effective pixel area A of the CCD 120 and smaller than the whole pixel area of the CCD 120. Here, hand shaking may be detected and stabilized using the image signal output from the CCD 120.

Also, the present invention may be applied to a digital camera, digital camcorder, a monitoring camera such as a closed circuit television (CCTV), a camera built in a mobile phone, or other photographing apparatuses.

As described above, according to the present invention, a size of an image that may be read from a memory is equal to a size of a whole pixel area (including effective and reserved pixel areas) of an image pickup device. Thus, digital zooming is not required. As a result, the quality of a reproduced and/or recorded image may be prevented from being deteriorated. Also, an angular velocity sensor, a prism, and a high pixel image pickup device are not used. Thus, manufacturing unit costs of a photographing apparatus may be lowered.

The foregoing embodiment and advantages are merely exemplary and are not to be construed as limiting the present invention. The present teaching may be readily applied to other types of apparatuses. Also, the description of the embodiments of the present invention is intended to be illustrative, and not to limit the scope of the claims, and many alternatives, modifications, and variations will be apparent to those skilled in the art.

What is claimed is:

1. A photographing apparatus, comprising:
an image pickup device for photographing an optical image of an object focused on an optical surface having an effective pixel area and a reserved pixel area of predetermined size prepared outside the effective pixel area to generate an image signal;
an image pickup device driver for driving the image pickup device to output an image signal generated in a pixel area greater than the effective pixel area;
a signal processor performing predetermined signal processing on the image signal output from the image pickup device;
a memory storing the image signal that has undergone the predetermined signal processing in the unit of field; and
an auto-stabilizer producing an auto-stabilized area using the image signal stored in the memory.

2. The photographing apparatus of claim 1, wherein
a memory controller reads an image signal corresponding to the auto-stabilized area from the memory; and
a display unit reproduces the image signal read by the memory controller.

3. The photographing apparatus of claim 1, wherein
the image pickup device drives the image pickup device to output image signals generated in the effective and reserved pixel areas.

4. The photographing apparatus of claim 1, wherein
the image pickup device is one of a charge coupled device and a metal oxide semiconductor type image pickup device.

5. The photographing apparatus of claim 4, wherein
the image pickup device is used in one of a digital camera, a digital camcorder, a monitoring camera, and a camera built in a mobile phone.

6. The photographing apparatus of claim 1, wherein
the signal processor has a correlated double sampling circuit (CDS)/auto gain controlling circuit (AGC)/analog-to-digital converter (ADC) 132 to facilitate signal processing.

7. The photographing apparatus of claim 6, wherein
the signal processor has a digital signal processor to facilitate signal processing.

8. The photographing apparatus of claim 3, wherein
the image pickup device drives the image pickup device to output image signals generated in substantially the entire effective and reserved pixel areas.

9. The photographing apparatus of claim 2, wherein
the display unit has a video encoder to facilitate converting the image signal.

10. The photographing apparatus of claim 9, wherein
the display unit has a liquid crystal display to display the converted image signal.

11. An auto-stabilization method for a photographing apparatus having an image pickup device photographing an optical image of an object focused on an optical surface having an effective pixel area and a reserved pixel area of predetermined size prepared outside the effective pixel area to generate an image signal, the auto-stabilization method comprising the steps of
driving the image pickup device to output an image signal generated in a pixel area greater than the effective pixel area;
performing predetermined signal processing on the image signal output from the image pickup device;
storing the image signal that has undergone the predetermined signal processing in the unit of field; and
producing an auto-stabilized area using the stored image signal.

12. The auto-stabilization method of claim 11, further comprising:
reading an image signal corresponding to the auto-stabilized area; and
reproducing the read image signal.

13. The auto-stabilization method of claim 11, wherein
the image pickup device is driven to output image signals generated in the effective and reserved pixel areas.

14. The auto-stabilization method of claim 11, wherein
the image pickup device is one of a charge coupled device and a metal oxide semiconductor type image pickup device.

15. The auto-stabilization method of claim 11, wherein
the photographing apparatus is one of a digital camera, a digital camcorder, a monitoring camera, and a camera built in a mobile phone.

16. An auto-stabilization method for a photographing apparatus, comprising:
focusing an optical image corresponding to an image to be photographed on an optical surface having a pixel area;
generating a first image signal corresponding to the optical image on the optical surface;
outputting the first image signal to a signal processor;
storing the outputted first image signal;
detecting shaking of the photographing apparatus by analyzing the stored first image signal;
producing an auto-stabilized area based on the amount of detected shaking;
reading a second image signal corresponding to the auto-stabilized area; and
reproducing the second image signal on a display unit.

17. An auto-stabilization method for a photographing apparatus according to claim 16, further comprising
focusing an optical image on a charge coupled device.

18. An auto-stabilization method for a photographing apparatus according to claim 16, further comprising
focusing an optical image on a metal oxide semiconductor pickup device.

19. An auto-stabilization method for a photographing apparatus according to claim 16, further comprising
generating a first image signal corresponding to the optical image of the entire pixel area of the optical surface.

20. An auto-stabilization method for a photographing apparatus according to claim 16, further comprising
performing predetermined signal processing on the outputted first image signal.
